(19) United States
(12) Patent Application Publication
(10) Pub. No.: US 2018/0215652 A1
(43) Pub. Date: Aug. 2, 2018

(54) ULTRAVIOLET LIGHT TRANSMITTING GLASS

(71) Applicant: ASAHI GLASS COMPANY, LIMITED, Chiyoda-ku (JP)

(72) Inventors: Takahiro SAKAGAMI, Haibara-gun (JP); Makoto SHIRATORI, Haibara-gun (JP)

(73) Assignee: ASAHI GLASS COMPANY, LIMITED, Chiyoda-ku (JP)

(21) Appl. No.: 15/939,509

(22) Filed: Mar. 29, 2018

Related U.S. Application Data
(63) Continuation of application No. PCT/JP2016/078482, filed on Sep. 27, 2016.

(30) Foreign Application Priority Data
Sep. 30, 2015 (JP) 2015-193598

(51) Int. Cl. C03C 3/089; C03C 3/087

(52) U.S. Cl. CPC C03C 3/089; C03C 3/087

(57) ABSTRACT

An ultraviolet light transmitting glass contains, in molar percentage on an oxide basis, 55% or more and 80% or less of SiO₂; 12% or more and 27% or less of B₂O₃; 4% or more and 20% or less of R₂O in total, where R represents at least one alkali metal selected from a group consisting of Li, Na, and K; 0% or more and 5% or less of Al₂O₃; 0% or more and 5% or less of R′O in total, where R′ represents at least one alkaline earth metal selected from a group consisting of Mg, Ca, Sr, and Ba; 0% or more and 5% or less of ZnO; and 1.5% or more and 20% or less of ZrO₂. The ultraviolet light transmitting glass with a thickness of 0.5 mm has a transmittance of 70% or more at a wavelength of 254 nm.

### CROSS-REFERENCE TO RELATED APPLICATIONS

This application is a continuation of prior International Application No. PCT/JP2016/078482 filed on Sep. 27, 2016 which is based upon and claims the benefit of priority from Japanese Patent Application No. 2015-193598 filed on Sep. 30, 2015; the entire contents of all of which are incorporated herein by reference.

### FIELD

The present invention relates to an ultraviolet light transmitting glass having high transmittance of light with a wavelength in an ultraviolet region.

### BACKGROUND

Known examples of ultraviolet light-emitting light source include a low-pressure mercury lamp and a high-pressure mercury lamp. In recent years, a small-sized and low-cost ultraviolet light LED (an ultraviolet light-emitting diode) has been widely used for more and more various usages such as a water sterilizer, a curing apparatus of an ultraviolet light curable resin, and an ultraviolet light sensor.

An apparatus with such an ultraviolet light source conventionally includes a quartz glass, which efficiently transmits ultraviolet light. However, manufacturing the quartz glass takes high cost.

In addition to the quartz glass, a phosphate glass and a borosilicate glass are known as a glass efficiently transmitting ultraviolet light. However, these glasses have low transmittance of light with a wavelength of 400 nm or less, particularly light with a wavelength of 200 nm or more and 280 nm or less (may be referred to as deep ultraviolet light, hereinafter).

### SUMMARY

The present invention has an object to provide an ultraviolet light transmitting glass having high transmittance of ultraviolet light, in particular, deep ultraviolet light, and weaker coloring due to ultraviolet light irradiation.

After considerations and efforts, the inventors have found that glass compositions of the ultraviolet light transmitting glass within a specific range enables the glass to have higher transmittance of deep ultraviolet light, and weaker coloring due to ultraviolet light irradiation.

Specifically, an ultraviolet light transmitting glass of the present invention contains, in molar percentage on an oxide basis, 55% or more and 80% or less of SiO₂; 12% or more and 27% or less of B₂O₃; 4% or more and 20% or less of R₂O in total, where R represents at least one alkali metal selected from a group consisting of Li, Na, and K; 0% or more and 5% or less of Al₂O₃; 0% or more and 5% or less of R′O in total, where R′ represents at least one alkaline earth metal selected from a group consisting of Mg, Ca, Sr, and Ba; 0% or more and 5% or less of ZnO; and 1.5% or more and 20% or less of ZrO₂. The ultraviolet light transmitting glass with a thickness of 0.5 mm has a transmittance of 70% or more at a wavelength of 254 nm.

The ultraviolet light transmitting glass of the present invention preferably does not substantially contain Al₂O₃.

The ultraviolet light transmitting glass of the present invention preferably contains 0.5% or more and 5% or less of Al₂O₃.

Further, the ultraviolet light transmitting glass of the present invention preferably does not substantially contain R′O.

Further, the ultraviolet light transmitting glass of the present invention may further contain 0.00005% or more and 0.01% or less of Fe₂O₃ and/or 0.0001% or more and 0.02% or less of TiO₂.

Further, the ultraviolet light transmitting glass of the present invention preferably contains substantially none of Cr₂O₃, NiO, CuO, CeO₂, V₂O₅, WO₃, MoO₃, MnO₂, and CoO.

Further, the ultraviolet light transmitting glass of the present invention preferably does not substantially contain Cl.

Further, the ultraviolet light transmitting glass of the present invention preferably has a deterioration in the transmittance of 5% or less at the wavelength of 254 nm in an ultraviolet light irradiation test, the deterioration being determined by the following expression (1).

Deterioration (%)=[(T0−T1)/T0]×100 Expression (1)

In the expression (1), T0 indicates initial transmittance of the ultraviolet light transmitting glass at the wavelength of 254 nm, the ultraviolet light transmitting glass has a thickness of 0.5 mm and optically polished surfaces opposite to each other, and T1 indicates transmittance of the ultraviolet light transmitting glass at the wavelength of 254 nm after irradiated with ultraviolet light having the wavelength of 254 nm and an intensity of 5 mW/cm² for 100 hours.

Further, the ultraviolet light transmitting glass of the present invention with a thickness of 0.5 mm preferably has transmittance of 80% or more at a wavelength of 365 nm.

Further, the ultraviolet light transmitting glass of the present invention preferably has an average thermal expansion coefficient of 30×10⁻⁷/° C. or more and 90×10⁻⁷/° C. or less in temperatures of 0° C. to 300° C.

According to the present invention, it is possible to obtain an ultraviolet light transmitting glass having higher transmittance of ultraviolet light, in particular, deep ultraviolet light, and weaker coloring due to ultraviolet light irradiation.

### DETAILED DESCRIPTION

Hereinafter, embodiments for carrying out the present invention will be described.

An ultraviolet light transmitting glass of the present invention contains, in molar percentage on an oxide basis, 55% or more and 80% or less of SiO₂; 12% or more and 27% or less of B₂O₃; 4% or more and 20% or less of R₂O in total, where R represents at least one alkali metal selected from a group consisting of Li, Na, and K; 0% or more and 5% or less of Al₂O₃; 0% or more and 5% or less of R′O in total, where R′ represents at least one alkaline earth metal selected from a group consisting of Mg, Ca, Sr, and Ba; 0% or more and 5% or less of ZnO; and 1.5% or more and 20% or less of ZrO₂

SiO₂ is a component for forming a basic structure of glass, and is essential. A content of SiO₂ less than 55% causes decreasing stability of the glass or weather resistance. The content of SiO₂ is preferably 55.5% or more, and more preferably 56% or more. The content of SiO₂ exceeding 80% causes increasing viscosity of a melt of the glass, resulting in reducing meltability significantly. The content of SiO₂ is preferably 77% or less, and more preferably 75% or less.

Al₂O₃ is a component for improving weather resistance of the glass. The glass contains Al₂O₃ exceeding 5% causes increasing viscosity of its melt increases, resulting in difficulty to achieve homogeneous melting of the glass. For improving the weather resistance of the glass, the content of Al₂O₃ is preferably 4.5% or less, more preferably 4.3% or less, still more preferably 4% or less, and the most preferably, Al₂O₃ is not substantially contained.

Why the substantial absence of Al₂O₃ is preferable in the present invention will be described below.

The transmittance of deep ultraviolet light through glass depends on a non-bridging oxygen amount in the glass, and the transmittance of deep ultraviolet light is considered to become lower as the non-bridging oxygen amount is larger. Al₂O₃ is a component reducing the non-bridging oxygen amount in the glass, and Al₂O₃ in the glass has been conventionally considered to make its transmittance of deep ultraviolet light high. However, testing the glass with various composition conditions of Al₂O₃ and others, the inventors have found that reducing the content of Al₂O₃ as much as possible or preferably no Al₂O₃ in the glass causes higher transmittance of deep ultraviolet light, which is contrary to conventional common general technical knowledge. Although its detailed mechanism has not been clear yet, it can be explained as follows.

Al₂O₃ is said to accompany an alkali metal component in the glass to form a network structure of glass, resulting in reducing non-bridging oxygen in the glass. However, the glass is in an amorphous state seemingly to form fluctuation of a glass structure. Specifically, increasing the content of Al₂O₃ causes tending to reduce the non-bridging oxygen amount in the glass on average, but the fluctuation of the structure peculiar to the amorphous state may cause an increase of the Al components which do not form the network structure but form modifier oxide (a structural defect). Such structural defects due to the Al components without forming the network structure seemingly form an absorption band of light in an ultraviolet region, resulting in lower ultraviolet light transmitting ability of the glass.

Note in the present invention, the state “a specific component is not substantially contained” means “not intentionally added”, and does not exclude “a content inevitably mixed from such as a raw material and not impairing expected properties”.

Meanwhile, Al₂O₃ is a component for suppressing coloring of glass due to ultraviolet light. A content of Al₂O₃ less than 0.5% may not sufficiently suppress the coloring of the glass due to ultraviolet light, depending on other compositions. For sufficiently suppressing the coloring of the glass due to ultraviolet light, the content of Al₂O₃ is preferably not less than 0.5% nor more than 5%.

B₂O₃ is a component for improving transmittance of deep ultraviolet light and suppressing coloring of glass due to ultraviolet light, and is essential. A content of B₂O₃ less than 12% may not cause a meaningful improvement in the transmittance of deep ultraviolet light. The content of B₂O₃ is preferably 13% or more, and more preferably 14% or more. The content of B₂O₃ exceeding 27% may cause striae due to volatilization, which may reduce yield of its productivity. The content of B₂O₃ is preferably 26% or less, and more preferably 25% or less.

R₂O (where R represents at least one alkali metal selected from a group consisting of Li, Na, and K) is a component for improving meltability of glass, and is essential. ΣR₂O (where ΣR₂O indicates a total amount of contents of Li₂O, Na₂O and K₂O) less than 4% causes lower meltability. ΣR₂O is preferably 4.5% or more, and more preferably 5% or more. ΣR₂O exceeding 20% causes lower weather resistance. ΣR₂O is preferably 18% or less, and more preferably 16% or less.

R′O (where R′ represents at least one alkaline earth metal selected from a group consisting of Mg, Ca, Sr, and Ba) is a component improving meltability, and is not essential but can be contained according to needs. ΣR′O (where ΣR′O is a total amount of contents of MgO, CaO, SrO and BaO) exceeding 5% causes lower weather resistance. A content of ΣR′O is preferably 4% or less, and more preferably 3% or less. Raw materials of R′O often contain relatively a lot of Fe₂O₃ and TiO₂ which cause lower transmittance of deep ultraviolet light, and thus R′O preferably is not substantially contained.

ZnO is a component for improving weather resistance of glass and reducing a deterioration in the ultraviolet light irradiation test, and can be contained according to needs. A content of ZnO exceeding 5% causes deteriorating a devitrification property of glass. The content of ZnO is preferably 4.5% or less, and more preferably 4% or less.

ZrO₂ is a component for improving weather resistance of glass and reducing a deterioration in the ultraviolet light irradiation test, namely, suppressing coloring of glass due to ultraviolet light, and it is essential. A content of ZrO₂ exceeding 20% may causes deteriorating meltability of glass. Further, the content of ZrO₂ less than 1.5% may not sufficiently suppress coloring of glass due to ultraviolet light. The content of ZrO₂ is preferably 1.7% or more, and more preferably 1.8% or more. Further, the content of ZrO₂ is preferably 15% or less, and more preferably 10% or less.

Fe₂O₃ is a component to exist in glass and absorb deep ultraviolet light to lessen the transmittance. However, mixing Fe₂O₃ in the grass from raw materials and manufacturing processes is very difficult to completely avoid. Accordingly, a content of Fe₂O₃ less than 0.00005% is not preferable because this cause a higher cost to manufacture the glass due to usage of refined high-cost glass raw materials, or the like. The content of Fe₂O₃ is preferably 0.0001% or more. The content of Fe₂O₃ exceeding 0.01% is not preferable, because this causes lower transmittance of deep ultraviolet light. The content of Fe₂O₃ is preferably 0.0065% or less, and more preferably 0.005% or less.

TiO₂ is a component to exist in glass and absorb deep ultraviolet light to lessen the transmittance, similarly to Fe₂O₃. However, mixing of TiO₂ from a glass raw material and manufacturing processes is very difficult to completely avoid. Accordingly, a content of TiO₂ less than 0.0001% is not preferable, because this causes a higher cost to manufacture the glass due to usage of refined high-cost glass raw materials, or the like. The content of TiO₂ is preferably 0.0003% or more. The content of TiO₂ exceeding 0.02% is not preferable, because this causes lower transmittance of deep ultraviolet light. The content of TiO₂ is preferably 0.015% or less, and more preferably 0.01% or less.

All of Cr₂O₃, NiO, CuO, CeO₂, V₂O₅, WO₃, MoO₃, MnO₂, and CoO are components to exist in glass and absorb deep ultraviolet light to lessen the transmittance. Accordingly, these components preferably are not substantially contained in the glass.

Cl may particularly increase a deterioration at a wavelength of 365 nm in the later-described ultraviolet light irradiation test, and thus Cl preferably is not substantially contained in glass.

F is a component which volatilizes during melting glass, and may cause striae in the glass, and thus F preferably is not substantially contained in the glass.

The ultraviolet light transmitting glass of the present invention may contain, in addition to the above components, SO₃ or SnO₂ in order to clarify the glass.

The ultraviolet light transmitting glass of the present invention has the transmittance of 70% or more at a wavelength of 254 nm in terms of spectral transmittance at a plate thickness of 0.5 mm. An apparatus for utilizing the deep ultraviolet light can be efficiently operated using the ultraviolet light transmitting glass with optical characteristics as above. The transmittance less than 70% is not preferable at the wavelength of 254 nm in terms of the spectral transmittance at the plate thickness of 0.5 mm, because this disturbs efficiently operating the apparatus. The transmittance at the wavelength of 254 nm described above is preferably 72% or more, more preferably 75% or more, and the most preferably 80% or more.

The ultraviolet light transmitting glass of the present invention may have the transmittance of 80% or more at the wavelength of 365 nm in terms of spectral transmittance at the plate thickness of 0.5 mm. An apparatus for utilizing the ultraviolet light with the wavelength of 365 nm can be efficiently operated using the ultraviolet light transmitting glass with optical characteristics as above. The transmittance less than 80% is not preferable at the wavelength of 365 nm in terms of the spectral transmittance at the plate thickness of 0.5 mm, because this disturbs efficiently operating the aforementioned apparatus. The transmittance at the wavelength of 365 nm is preferably 82% or more, more preferably 85% or more, and the most preferably 90% or more.

The ultraviolet light transmitting glass of the present invention suppresses ultraviolet light solarization (coloring of glass due to exposure to ultraviolet light). Concretely, a deterioration of the transmittance at the wavelength of 254 nm is preferably 5% or less in the ultraviolet light irradiation test to be described below.

In the ultraviolet light irradiation test, an ultraviolet light transmitting glass sample (which is also referred to as a glass sample, hereinafter) is manufactured by cutting an ultraviolet light transmitting glass into a 30 mm square plate shape, and performing optical polishing on both surfaces to obtain a thickness of 0.5 mm. Initial transmittance (T0) at the wavelength of 254 nm of the glass sample is measured. Subsequently, by using a physicochemical high-pressure mercury lamp, ultraviolet light is applied on the glass sample for 100 hours under a condition with an ultraviolet light irradiation intensity at the wavelength of 254 nm of about 5 mW/cm². After the irradiation with ultraviolet light for 100 hours, transmittance (T1) of the glass sample is measured at the wavelength of 254 nm. The deterioration of the transmittance at the wavelength of 254 nm is determined from the following expression (1), as a deterioration rate from the initial transmittance (T0) before the ultraviolet light irradiation.

Deterioration (%)=[(T0−T1)/T0]×100 Expression (1)

Besides, the deterioration in transmittance of the ultraviolet light transmitting glass of the present invention is preferably 5% or less at the wavelength of 365 nm after the glass sample is irradiated with the ultraviolet light under a condition similar to that of the above-described ultraviolet light irradiation test. Note that the deterioration in the transmittance at the wavelength of 365 nm is determined by the following expression (2).

Deterioration (%)=[(T2−T3)/T2]×100 Expression (2)

Note that in the expression (2), T3 indicates transmittance of the glass sample at the wavelength of 365 nm after the ultraviolet light irradiation, and T2 indicates initial transmittance of the glass sample at the wavelength of 365 nm before the ultraviolet light irradiation.

The ultraviolet light transmitting glass of the present invention preferably has an average thermal expansion coefficient of not less than 30×10⁻⁷/° C. nor more than 90×10⁻⁷/° C. in a temperature range of not less than 0° C. nor more than 300° C. When the ultraviolet light transmitting glass is used for an ultraviolet light source apparatus, for example, the ultraviolet light transmitting glass is adhered to a package material so as to hermetically seal a light source. A temperature of the ultraviolet light source increases in accordance with light emission, thus a large difference in thermal expansion coefficients between the ultraviolet light transmitting glass and the package material may cause peeling and breakage to disturb maintaining a hermetic state of the light source. The package is made of a material such as glass, crystallized glass, ceramics, or alumina in consideration of heat resistance. In order to reduce the thermal expansion coefficient difference between the package material and the ultraviolet light transmitting glass, the ultraviolet light transmitting glass preferably has the average thermal expansion coefficient of not less than 30×10⁻⁷/° C. nor more than 90×10⁻⁷/° C. in the temperature range of not less than 0° C. nor more than 300° C. The average thermal expansion coefficient of the ultraviolet light transmitting glass out of the above-described temperature range causes larger thermal expansion coefficient difference between the package material and the ultraviolet light transmitting glass, and this may disturb maintaining a hermetic state of the ultraviolet light source apparatus as described above.

Besides, a difference in average thermal expansion coefficients in the temperature range of not less than 0° C. nor more than 300° C. between the ultraviolet light transmitting glass and a member to be joined to the ultraviolet light transmitting glass is preferably 20×10⁻⁷/° C. or less, more preferably 10×10⁻⁷/° C. or less, and the most preferably 5×10⁻⁷/° C. or less.

Next, a manufacturing method of the ultraviolet light transmitting glass of the present invention will be described.

First, glass raw materials to constitute each component of a desired composition are prepared. The glass raw materials used in the present invention can include compounds such as oxide, hydroxide, carbonate, sulfate, nitrate, fluoride and chloride.

Next, these glass raw materials are mixed to be glass having the desired composition, and put into a melting tank. The melting tank is a container made of a material selected from platinum, a platinum alloy, and a refractory. In the present invention, the container of platinum or a platinum alloy is a container made of a metal or an alloy selected from the group consisting of platinum (Pt), iridium (Ir), palladium (Pd), rhodium (Rh), gold (Au), and an alloy of these, and the container can be used for high-temperature melting.

Babbles and striae are removed from the glass melted in the aforementioned melting tank by using a deaeration tank and a stirring tank disposed on a downstream side to obtain homogenized and high-quality glass with little glass defect. The above-described glass is molded into a shape by flowing into a mold through a nozzle to perform slip casting, or rolling out into a plate shape. The slowly cooled glass is processed, such as slicing and polishing, to form a glass with a predetermined shape.

The ultraviolet light transmitting glass of the present invention can be suitably used for an apparatus with an ultraviolet light source (for example, a UV-LED, and a UV laser), a support substrate to manufacture a semiconductor wafer on the premise of UV peeling, an arc tube, and so on. Examples of the above-described apparatus include, but are not limited to, a curing apparatus of an ultraviolet light curable resin composition, a light source cover glass of an ultraviolet light sensor, and a water sterilizer. Further, the ultraviolet light transmitting glass of the present invention can have appropriate forms such as a tubular shape and a compact, in addition to the plate shape, according to usages.

The UV-LED device includes, for example, a UV-LED chip as a light source provided on a recess or a flat surface of a package having a base material such as a resin, a metal, or ceramics, which are electrically connected. A light emission side window member is constituted by a transparent material with a UV transmitting property, and the light emission side window member and the base material are hermetically sealed. The UV-LED device generates heat simultaneously with the UV light emission. Here, a large difference in thermal expansion coefficients between the base material and the transparent material causes breakage and cracks at a joint part between the base material and the transparent material to significantly lower product reliability.

However, using the ultraviolet light high-transmitting glass of the present invention with controlled thermal expansion coefficient for the transparent material can reduce the thermal expansion coefficient difference between the base material and the transparent material, and the ultraviolet light high-transmitting glass also has fine weather resistance. This can provide the UV-LED device having a smaller reduction of transmittance in a visible region and fewer breakages and cracks after long time usage.

The UV sensor includes, for example, a light sensor chip with sensitivity for a UV wavelength provided on a recess or a flat surface of a package having a base material such as a resin, a metal, or ceramics, which are electrically connected. A light emission side window member is constituted by a transparent material with a UV transmitting property, and the light emission side window member and the base material are hermetically sealed. Here, a large difference in the thermal expansion coefficients between the base material and the transparent material causes breakage and cracks in each member to significantly lower product reliability.

However, using the ultraviolet light high-transmitting glass of the present invention with the controlled thermal expansion coefficient for the transparent material can reduce the thermal expansion coefficient difference between the base material and the transparent material, and the ultraviolet light high-transmitting glass also includes fine weather resistance. This can provide the UV sensor having a smaller reduction of transmittance in a visible region and fewer breakages and cracks after long time usage.

The UV laser device includes, for example, a UV laser as a light source provided on a recess or a flat surface of a package having a base material such as a metal or ceramics such as AlN, which are electrically connected. A light emission side window member is constituted by a transparent material with a UV transmitting property, and the light emission side window member and the base material are hermetically sealed. The UV laser device generates heat simultaneously with the UV light emission. Here, a large difference in thermal expansion coefficients between the base material and the transparent material causes breakage and cracks at a joint part between the base material and the transparent material to significantly lower product reliability.

However, using the ultraviolet light high-transmitting glass of the present invention with the controlled thermal expansion for the transparent material can reduce the thermal expansion coefficient difference between the base material and the transparent material, and the ultraviolet light high-transmitting glass also includes fine weather resistance. Thus, the UV laser device can have a smaller reduction of transmittance in a visible region and fewer breakages and cracks after long time usage.

A light source for water sterilization includes, for example, a light source having a substrate, with UV-LEDs arranged in a line shape, and sealed in a glass tube with a UV transmitting property. Here, using the ultraviolet light transmitting glass of the present invention formed into a tubular shape for the glass tube can provide the tubular UV-LED light source having high transmittance of deep ultraviolet light and high sterilizing property.

Note that the light source for the water sterilization used in a state of being immersed into water or brought into contact with water may increase a temperature difference between an inner surface of the glass tube heated by heat from the light source and an outer surface of the glass tube contact with water. For this reason, for preventing breakage of the glass tube due to heat shock, the glass of the glass tube preferably has low thermal expansion coefficient, and the ultraviolet light transmitting glass of the present invention is suitable also in terms of this point.

When the ultraviolet light transmitting glass of the present invention is used for this usage, the average thermal expansion coefficient in a temperature range of not less than 0° C. nor more than 300° C. is preferably 70×10⁻⁷/° C. or less, more preferably 60×10⁻⁷/° C. or less, and still more preferably 50×10⁻⁷/° C. or less.

Further, a light source for the water sterilization includes a UV-LED array which has UV-LEDs arranged in a line shape and is attached between a plurality of glass plates. Here, using the ultraviolet light transmitting glass of the present invention formed into a plate shape for each glass plate can provide the plate-shaped UV-LED array having high transmittance of deep ultraviolet light and high sterilizing property.

A light-emission tube of ultraviolet light includes, for example, a glass tube having an ultraviolet light source attached therein. Here, using the ultraviolet light transmitting glass of the present invention formed into the tubular shape for the glass tube can provide the light-emission tube having high transmittance of deep ultraviolet light.

For example, in a manufacturing process of a semiconductor wafer, a support substrate is used for a back grind use or the like of silicon (Si). Thinner silicon substrates obtained by using the support substrate contribute to reduction in size and thickness of a chip in cellular phones, digital AV devices, IC cards, and so on. Currently, reclaimed Si substrates are often employed as the support substrate for back grind of the semiconductor wafer, but heat treatment or physical process for a peeling after the back grind causes programs of a longer process time and lower yield of its productivity.

The problems can be solved by using the ultraviolet light high-transmitting glass of the present invention capable of controlling the thermal expansion coefficient as the support substrate. Specifically, an ultraviolet light transmitting glass substrate whose thermal expansion coefficient is consistent with that of silicon is used as the support substrate, and the support substrate is adhered to a silicon substrate with an ultraviolet light curable resin (a compound having an ultraviolet light absorbing structure) or the like before a back grind process. After the back grind, the resultant is exposed to high-intensity ultraviolet light to lessen adhesiveness of the above-described ultraviolet light curable resin, which enables easy and rapid peeling of the support substrate. In addition, this can lessen the process time and improve yield of its productivity.

Further, the ultraviolet light transmitting glass of the present invention can be suitably used for a cell incubation container, and a member to observe and measure cells (an instrument for organism analysis). In a cell incubation field, cells are observed by a method of expressing fluorescence protein in a desired cell or introducing fluorescence dye and observing the fluorescence. The ultraviolet light transmitting glass of the present invention emits small fluorescence from the glass itself, thus fluorescence from the container or the member made of the glass does not disturb high accuracy measurement of weak fluorescence emitted from the cell. Examples of such a container and a member include, but are not limited to, a slide glass, a dish for cell incubation, a well plate, a micro plate, a cell incubation container, an analysis chip (a biochip, a microchemical chip), and a microchannel device.

### EXAMPLES

Hereinafter, the present invention will be described based on examples. Example 1 to Example 13 are examples of the present invention, and Example 14 and Example 15 are comparative examples. Samples used for respective examples were produced as follows.

First, glass raw materials were mixed to become glass compositions listed in Table 1, and the glass raw material formulation was subjected to melting, stirring, and clarifying for five hours at a temperature of not less than 1300° C. nor more than 1650° C. in an electric furnace with platinum crucible and a heating element of molybdenum silicide. This molten substance was subjected to slip casting in a cast iron mold, and slowly cooled, to thereby obtain a glass sample (a glass block) of 800 g. Further, slicing, polishing, and so on were performed on this glass block to obtain a glass plate with a predetermined shape (30 mm×30 mm×0.5 mm).

The obtained glass block and glass plates are measured for the transmittance of light at the wavelength of 254 nm at the plate thickness of 0.5 mm, the transmittance of light at the wavelength of 365 nm at the plate thickness of 0.5 mm, the deterioration of the transmittance at each of the wavelength of 254 nm and the wavelength of 365 nm in the ultraviolet light irradiation test, and the average thermal expansion coefficient in the temperature range of not less than 0° C. nor more than 300° C. Results thereof are presented in lower columns in Table 1.

TABLE 1

| Glass composition | | Example | Example | Example | Example | Example | Example | Example |
|---|---|---|---|---|---|---|---|---|
| (mol %) | | 1 | 2 | 3 | 4 | 5 | 6 | 7 |
| SiO₂ | | 66.67 | 63.43 | 63.17 | 61.59 | 62.81 | 62.19 | 61.59 |
| B₂O₃ | | 18.67 | 21.72 | 21.63 | 21.09 | 21.51 | 21.30 | 21.09 |
| Li₂O | | 0.00 | 0.00 | 0.73 | 0.48 | 0.00 | 0.00 | 0.00 |
| Na₂O | | 12.37 | 12.11 | 12.06 | 11.76 | 11.99 | 11.87 | 11.76 |
| K₂O | | 0.00 | 0.57 | 0.24 | 1.07 | 0.56 | 0.56 | 0.55 |
| Al₂O₃ | | 0.00 | 0.00 | 0.00 | 0.00 | 0.00 | 0.00 | 0.00 |
| ZrO₂ | | 2.08 | 1.96 | 1.96 | 3.81 | 2.93 | 3.88 | 4.82 |
| Fe₂O₃ | | 0.0010 | 0.0010 | 0.0010 | 0.0010 | 0.0010 | 0.0010 | 0.0010 |
| TiO₂ | | 0.0006 | 0.0004 | 0.0004 | 0.0005 | 0.0006 | 0.0005 | 0.0005 |
| SnO₂ | | 0.01 | 0.01 | 0.01 | 0.01 | 0.01 | 0.01 | 0.01 |
| SO₃ | | 0.21 | 0.20 | 0.20 | 0.19 | 0.19 | 0.19 | 0.19 |
| Total | | 100.00 | 100.00 | 100.00 | 100.00 | 100.00 | 100.00 | 100.00 |
| Li₂O + Na₂O + K₂O | | 12.37 | 12.68 | 13.04 | 13.30 | 12.55 | 12.43 | 12.31 |
| Transmittance [%] at a | | 79.82 | 84.44 | 83.13 | 83.06 | 82.04 | 81.86 | 82.29 |
| wavelength of 254 nm | | | | | | | | |
| Before ultraviolet | | | | | | | | |
| light irradiation | | | | | | | | |
| Transmittance [%] at a | | 76.43 | 80.96 | 80.11 | 80.27 | 80.29 | 80.30 | 80.89 |
| wavelength of 254 nm | | | | | | | | |
| After ultraviolet | | | | | | | | |
| light irradiation | | | | | | | | |
| Deterioration [%] at | | 4.25 | 4.11 | 3.64 | 3.35 | 2.13 | 1.90 | 1.71 |
| wavelength of 254 nm | | | | | | | | |
| Transmittance [%] at a | | 91.08 | 91.29 | 90.91 | 90.72 | 91.18 | 90.66 | 90.83 |
| wavelength of 365 nm | | | | | | | | |
| Before ultraviolet | | | | | | | | |
| light irradiation | | | | | | | | |
| Transmittance [%] at a | | 87.73 | 88.27 | 88.16 | 88.18 | 89.04 | 89.03 | 89.22 |
| wavelength of 365 nm | | | | | | | | |
| After ultraviolet | | | | | | | | |
| light irradiation | | | | | | | | |
| Deterioration [%] at | | 3.68 | 3.31 | 3.02 | 2.80 | 2.34 | 1.79 | 1.78 |
| wavelength of 365 nm | | | | | | | | |
| Average thermal | | 64.2 | 67.8 | 68.0 | 68.8 | 67.2 | 66.2 | 65.6 |
| expansion coefficient | | | | | | | | |
| in 0 to 300° C. | | | | | | | | |
| [×10⁻⁷/° C.] | | | | | | | | |
| Glass composition | Example | Example | Example | Example | Example | Example | Example | Example |
| (mol %) | 8 | 9 | 10 | 11 | 12 | 13 | 14 | 15 |
| SiO₂ | 60.99 | 61.29 | 61.59 | 59.54 | 59.84 | 58.74 | 64.08 | 65.08 |
| B₂O₃ | 20.89 | 20.99 | 21.09 | 20.39 | 20.49 | 20.11 | 21.94 | 22.29 |
| Li₂O | 0.00 | 0.00 | 0.00 | 0.00 | 0.00 | 0.00 | 0.00 | 0.00 |
| Na₂O | 11.64 | 11.22 | 10.79 | 10.43 | 11.42 | 11.21 | 12.23 | 12.43 |
| K₂O | 0.55 | 0.55 | 0.55 | 0.53 | 0.54 | 0.53 | 0.00 | 0.00 |
| Al₂O₃ | 0.00 | 0.00 | 0.00 | 0.00 | 1.89 | 3.70 | 1.55 | 0.00 |
| ZrO₂ | 5.73 | 5.76 | 5.79 | 8.92 | 5.62 | 5.52 | 0.00 | 0.00 |
| Fe₂O₃ | 0.0010 | 0.0010 | 0.0010 | 0.0009 | 0.0009 | 0.0009 | 0.0010 | 0.0010 |
| TiO₂ | 0.0005 | 0.0004 | 0.0006 | 0.0004 | 0.0004 | 0.0005 | 0.0004 | 0.0006 |
| SnO₂ | 0.01 | 0.01 | 0.01 | 0.01 | 0.01 | 0.01 | 0.00 | 0.00 |
| SO₃ | 0.19 | 0.19 | 0.19 | 0.18 | 0.18 | 0.18 | 0.20 | 0.20 |
| Total | 100.00 | 100.00 | 100.00 | 100.00 | 100.00 | 100.00 | 100.00 | 100.00 |
| Li₂O + Na₂O + K₂O | 12.19 | 11.77 | 11.34 | 10.96 | 11.96 | 11.74 | 12.23 | 12.43 |
| Transmittance [%] at a | 82.40 | 82.86 | 82.61 | 81.25 | 81.02 | 81.13 | 76.5 | 80.15 |
| wavelength of 254 nm | | | | | | | | |
| Before ultraviolet | | | | | | | | |
| light irradiation | | | | | | | | |
| Transmittance [%] at a | 81.23 | 81.52 | 81.62 | 80.71 | 80.37 | 80.09 | 71.9 | 75.40 |
| wavelength of 254 nm | | | | | | | | |
| After ultraviolet | | | | | | | | |
| light irradiation | | | | | | | | |
| Deterioration [%] at | 1.41 | 1.62 | 1.20 | 0.67 | 0.80 | 1.29 | 5.96 | 5.92 |
| wavelength of 254 nm | | | | | | | | |
| Transmittance [%] at a | 91.05 | 91.06 | 91.05 | 90.67 | 90.65 | 90.61 | 91.9 | 91.65 |
| wavelength of 365 nm | | | | | | | | |
| Before ultraviolet | | | | | | | | |
| light irradiation | | | | | | | | |
| Transmittance [%] at a | 89.32 | 89.03 | 89.37 | 89.82 | 89.08 | 89.21 | 86.8 | 86.33 |
| wavelength of 365 nm | | | | | | | | |
| After ultraviolet | | | | | | | | |
| light irradiation | | | | | | | | |
| Deterioration [%] at a | 1.90 | 2.23 | 1.84 | 0.94 | 1.73 | 1.54 | 5.55 | 5.80 |
| wavelength of 365 nm | | | | | | | | |
| Average thermal | 64.8 | 63.2 | 61.9 | 59.6 | 65.2 | 68.0 | 64.7 | 62.8 |
| expansion coefficient | | | | | | | | |
| in 0 to 300° C. | | | | | | | | |
| [×10⁻⁷/° C.] | | | | | | | | |

The transmittance of the glass was measured with an ultraviolet visible near-infrared spectrophotometer (manufactured by JASCO Corporation, model number: V-570).

The deterioration of the transmittance in the ultraviolet light irradiation test was measured in the following manner. First, regarding the glass plate having a predetermined shape (30 mm×30 mm×0.5 mm) and whose both surfaces were optically polished to obtain the thickness of 0.5 mm, transmittance of each of light with the wavelength of 254 nm and light with the wavelength of 365 nm was measured with the ultraviolet visible near-infrared spectrophotometer (manufactured by JASCO Corporation, model number: V-570). Next, by using the physicochemical high-pressure mercury lamp (manufactured by HARISON TOSHIBA LIGHTING Corporation, model number: H-400P), the glass plate was irradiated with ultraviolet light for 100 hours under a condition with an ultraviolet light irradiation intensity of about 5 mW/cm² at the wavelength of 254 nm, and then the transmittance of the glass plate was measured again with the ultraviolet visible near-infrared spectrophotometer. Changes in the transmittance of the glass plate were compared before and after the ultraviolet light irradiation at each of the wavelength of 254 nm and the wavelength of 365 nm.

The “change was observed in the transmittance” corresponds to the deterioration (%) (=[(the transmittance before the ultraviolet light irradiation−the transmittance after the ultraviolet light irradiation)/the transmittance before the ultraviolet light irradiation]×100) at each wavelength exceeding 5%, and the “no change was observed in the transmittance” corresponds to the deterioration of 5% or less. Each of the glasses of Example 1 to Example 13 being the examples were determined to be “change was not observed in the transmittance” before and after the ultraviolet light irradiation. On the other hand, the glasses of Example 14 and Example 15 were determined to be “change was observed in the transmittance” before and after the ultraviolet light irradiation, and the deterioration exceeds 5% before and after the ultraviolet light irradiation at each of the wavelength of 254 nm and the wavelength of 365 nm.

The thermal expansion coefficient is determined by measuring a difference in elongations of the glass at 0° C. and 300° C., and calculating an average linear expansion coefficient in not less than 0° C. nor more than 300° C. based on the change amount of these lengths.

Concrete measurement methods are as follows. A glass for measurement is processed into a glass bar having a circular cross section (length: 100 mm, outer diameter: not less than 4 mm nor more than 6 mm). Next, the glass is held by a quartz holder, it is retained at 0° C. for 30 minutes, and then the length is measured with a micro-gauge. Next, the glass is put into an electric furnace at 300° C., it is retained for 30 minutes, and then the length is measured with the micro-gauge. The thermal expansion coefficient is calculated from a difference in measured elongations of the glass at 0° C. and 300° C. Note that the thermal expansion coefficient of a platinum bar (length: 100 mm, outer diameter: 4.5 mm, thermal expansion coefficient: 92.6×10⁻⁷/° C.) is similarly measured by using a difference in elongations at 0° C. and 300° C., and when the thermal expansion coefficient of the platinum bar deviates from 92.6×10⁻⁷/° C., the measurement result of the thermal expansion coefficient of the glass is corrected by using the deviated amount.

Each of the glasses of Example 1 to Example 13 has the transmittance of 70% or more at the wavelength of 254 nm at the plate thickness of 0.5 mm, the transmittance of 80% or more at the wavelength of 365 nm at the plate thickness of 0.5 mm, and this indicates each of the glasses having high ultraviolet light transmittance.

Next, each of the glasses of the examples was checked whether or not an adhesion between the glass and a joint member can be maintained even if a temperature change occurs. As presented in Table 2, each of the glasses of the examples 1 and 2 (the glasses of Example 9) and the comparative examples 1 and 2 (the quartz glass and the soda lime glass) was adhered to a joint member having a predetermined thermal expansion coefficient (an average linear expansion coefficient in a temperature range of not less than 0° C. nor more than 300° C.). Next, the glass and the joint member adhered to each other were input to an electric furnace at 500° C., heated for 30 minutes, and then taken out of the electric furnace to be rapidly cooled in a room temperature atmosphere. Subsequently, the adhesion state between the glass and the joint member was examined, and presence/absence of cracks of the glass was checked. The glass with the cracks was evaluated as “B”, and the glass without the cracks was evaluated as “A”. Note that in Table 2, LTCC means Low temperature Co-fired Ceramics.

TABLE 2

| | | | Comparative | Comparative |
|---|---|---|---|---|
| | Example 1 | Example 2 | Example 1 | Example 2 |
| Kind of glass | Glass of | Glass of | Quartz glass | Soda lime |
| | Example 9 | Example 9 | | glass |
| Average thermal expansion | 63.2 | 63.2 | 5 | 85 |
| coefficient of glass in | | | | |
| temperature range of 0 to | | | | |
| 300° C. [×10⁻⁷/° C.] | | | | |
| Kind of joint member | Borosilicate | LTCC | LTCC | Borosilicate |
| | glass | | | glass |
| Average thermal expansion | 63 | 60 | 60 | 48 |
| coefficient of joint member in | | | | |
| temperature range of 0 to | | | | |
| 300° C. [×10⁻⁷/° C.] | | | | |
| Difference in average thermal | 0.2 | 3.2 | 55 | 37 |
| expansion coefficients between | | | | |
| glass and joint member | | | | |
| [×10⁻⁷/° C.] | | | | |
| Difference in average thermal | A | A | B | B |
| expansion coefficients between | | | | |
| glass and joint member [× | | | | |
| 10⁻⁷/° C.] | | | | |

As presented in Table 2, when a difference in average thermal expansion coefficients between the glass and the joint member was large, the cracks of the glass occurred when the temperature change occurred on both of them. On the contrary, when the average thermal expansion coefficient of the glass was in the range of not less than 30×10⁻⁷/° C. nor more than 90×10⁻⁷/° C., and the average thermal expansion coefficient difference between the glass and the joint member was 20×10⁻⁷/° C. or less, the cracks of the glass did not occur during the temperature change on both of them.

According to the present invention, it is possible to obtain an ultraviolet light transmitting glass having higher transmittance of ultraviolet light, in particular, deep ultraviolet light, and weaker coloring due to ultraviolet light irradiation.

What is claimed is:

1. An ultraviolet light transmitting glass comprising, in molar percentage on an oxide basis:
55% or more and 80% or less of SiO₂;
12% or more and 27% or less of B₂O₃;
4% or more and 20% or less of R₂O in total, where R represents at least one alkali metal selected from a group consisting of Li, Na, and K;
0% or more and 5% or less of Al₂O₃;
0% or more and 5% or less of R′O in total, where R′ represents at least one alkaline earth metal selected from a group consisting of Mg, Ca, Sr, and Ba;
0% or more and 5% or less of ZnO; and
1.5% or more and 20% or less of ZrO₂, wherein
the ultraviolet light transmitting glass with a thickness of 0.5 mm has a transmittance of 70% or more at a wavelength of 254 nm.

2. The ultraviolet light transmitting glass according to claim 1, comprising substantially no Al₂O₃.

3. The ultraviolet light transmitting glass according to claim 1, comprising 0.5% or more and 5% or less of Al₂O₃.

4. The ultraviolet light transmitting glass according to claim 1, comprising substantially no R′O.

5. The ultraviolet light transmitting glass according to claim 1, further comprising:
0.00005% or more and 0.01% or less of Fe₂O₃ and/or
0.0001% or more and 0.02% or less of TiO₂.

6. The ultraviolet light transmitting glass according to claim 1, comprising
substantially none of Cr₂O₃, NiO, CuO, CeO₂, V₂O₅, WO₃, MoO₃, MnO₂, and CoO.

7. The ultraviolet light transmitting glass according to claim 1, comprising
substantially no Cl.

8. The ultraviolet light transmitting glass according to claim 1, wherein
a deterioration in the transmittance at the wavelength of 254 nm determined by the following expression (1) is 5% or less in an ultraviolet light irradiation test.
Deterioration [%]=[(T0−T1)/T0]×100 Expression (1)
where T0 indicates initial transmittance of the ultraviolet light transmitting glass at the wavelength of 254 nm, the ultraviolet light transmitting glass having a thickness of 0.5 mm and optically polished surfaces opposite to each other, and T1 indicates transmittance of the ultraviolet light transmitting glass at the wavelength of 254 nm after irradiated with ultraviolet light having the wavelength of 254 nm and an intensity of 5 mW/cm² for 100 hours.

9. The ultraviolet light transmitting glass according to claim 1, wherein
the ultraviolet light transmitting glass with a thickness of 0.5 mm has a transmittance of 80% or more at a wavelength of 365 nm.

10. The ultraviolet light transmitting glass according to claim 1, wherein
the ultraviolet light transmitting glass has an average thermal expansion coefficient of 30×10⁻⁷/° C. or more and 90×10⁻⁷/° C. or less in temperatures of 0° C. to 300° C.
